(19) United States
(12) Patent Application Publication
(10) Pub. No.: US 2021/0309026 A1
(43) Pub. Date: Oct. 7, 2021

(54) MOVABLE THERMAL PRINTING DEVICE

(71) Applicant: CHIEN HWA COATING TECHNOLOGY, INC., HSINCHU CITY (TW)

(72) Inventor: HUNGYI PENG, HSINCHU CITY (TW)

(21) Appl. No.: 16/929,583

(22) Filed: Jul. 15, 2020

(30) Foreign Application Priority Data
Apr. 6, 2020 (TW) 109111444

(51) Int. Cl. B41J 13/03; B41J 2/32; B41J 25/312; B41J 29/387

(52) U.S. Cl. CPC B41J 13/03; B41J 2/32; B41J 2202/31; B41J 29/387; B41J 25/312

(57) ABSTRACT

The present invention relates to a movable thermal printing device, which comprises a gear set, a pressing roller set, and a heating component. The gear set includes a first motor, a first gear, and a rack gear. The pressing roller set includes a frame, a first roller, and a second motor. A sensing medium is attached below the first roller. When the first gear rotates counterclockwise, the rack gear, the pressing roller set, and the sensing medium will be driven to move upwards and away from the heating component. When the first gear rotates clockwise, the rack gear, the pressing roller set, and the sensing medium will be driven to move downwards and contact the heating component for printing sensing medium and for avoiding the sensing medium from contacting the heating component in reverse rotation and thus avoiding the problems of damages or print failure.

### FIELD OF THE INVENTION

The present invention relates generally to a movable printing device, and particularly to a thermal printing device with separable sensing medium and heating component using a gear set.

### BACKGROUND OF THE INVENTION

As technologies and commerce develop, invoices re receipts are required while paying a bill. Hence, a printer is included in a cashier. In particular, a heat sensitive printer (or a thermal printer) is a popular product widely adopted in retail, catering, and transportation businesses for printing receipts, price tags, or transportation details. As the applications of printers are extended, the types of printing media adopted by users vary. Since the structure of the thermal printer can be made small, it is extensively adopted. Thermal printers uses thermal paper (or called heat sensitive paper).

The thermal paper adopts a chemical material coated thereon so that the color of the paper can be changed after being heated. No ink is required in the process. The thermal paper can be used in a thermal printer disposed in a lightweight and small-sized device such as a fax machine, an addometer, a cashier, and a credit-card terminal for reducing the cost.

The surface of the thermal paper will be coated with solid dye and appropriate base material, such as fluorane-type invisible dye and octadecylphosphonic acid. When the base material is heated to the melting point, the dye will react with the acid material and turn to the colored state. The base material can be cooled down easily, and the colored state of the dye will be stored in a substable state. But the color still will fade after a period of time. Thereby, the thermal paper is only suitable for applications not requiring long-term storage.

Normally, the dye will turn into black after being heated. But sometimes, dyes turning into blue or red will be adopted instead. An open heat source, such as flames, will change the color of the paper. Rubbing the paper rapidly using a nail also provides sufficient thermal energy to generate a colored mark. Right before the thermal paper roll is running up, a red stripe will appear on the edge for reminding the user of replacing the paper roll.

In the thermal printing device according to the prior art, after finishing printing, the printing medium needs to pass the thermal print head in the reverse direction of the feed direction. As the printing medium passes by the thermal print head, the tip of the thermal print head and the printing medium collides, leading to damages or peelings of the thermal print head and printing medium. Even worse, the collision might lead to print failure.

Accordingly, the present invention provides a movable thermal printing device. By using the gear set to separate the heating component of the thermal print head and the printing medium, the problem of print failure caused by the collision between the tip of the thermal print head and the printing medium can be improved.

### SUMMARY

An objective of the present invention is to provide a movable thermal printing device for avoiding the possible collision between the tip of the thermal print head and the printed sensing medium when the latter passes by the heating component reverse to the feed direction after finishing printing and thus avoiding the problems of damages or peelings of the thermal print head and the printed thermal medium or print failure.

To achieve the above objective, the present invention discloses a movable thermal printing device, which comprises a gear set, a pressing roller set, and a heating component. The gear set includes a first motor, a first gear, and a rack gear. The first motor is disposed at a first shaft. The first gear is disposed on one side of the first motor and fixed at the first shaft. The first motor drives the first gear to rotate. The rack gear is disposed on one side of the first gear. The rack gear are in mesh with the first gear. The first gear drives the rack gear to move up and down. The pressing roller set is fixed below the gear set and includes a frame, a first roller, and a second motor. The frame is fixed below the rack gear and extends downwards with two hanging arms. The first roller is pivoted between the two hanging arms. The second motor is disposed on one side of the frame and a second shaft of the second motor is fixed at the first roller. The second motor drives the first roller to rotate. The heating component is disposed below the first roller. A sensing medium is attached below the first roller. One end of the sensing medium is disposed at a second roller. The other end of the sensing medium is disposed at a third roller and extends outwards. When the first gear rotates counterclockwise, the rack gear, the pressing roller set, and the sensing medium will be driven to move upwards and away from the heating component. When the first gear rotates clockwise, the rack gear, the pressing roller set, and the sensing medium will be driven to move downwards and contact the heating component for printing sensing medium and for avoiding the possible collision between the tip of the thermal print head and the printed sensing medium when the latter passes by the heating component reverse to the feed direction after finishing printing and thus avoiding the problems of damages or peelings of the thermal print head and the printed thermal medium or print failure.

According to an embodiment of the present invention, the movable thermal printing device further comprises an alignment roller disposed on the third roller. The sensing medium passes between the alignment roller and the third roller.

According to an embodiment of the present invention, a circuit board is disposed below the heating component.

According to an embodiment of the present invention, the first motor and the second motor are stepping motors.

To achieve the above objective, the present invention discloses a movable thermal printing device, which comprises a pressing roller set, a heating component, and a gear set. The pressing roller set includes a fourth roller and a third motor. A third shaft of the third motor is fixed on one side of the fourth roller and the third motor drives the fourth roller to rotate. The heating component corresponds to the fourth roller and is disposed below a sensing medium. The heating component is fixed at one end of a connecting rod. Second gear teeth are disposed at the other end of the connecting rod. The gear set is disposed on one side of the heating component and includes a second gear and a fourth motor. The second gear is disposed on one side of the connecting rod. Third gear teeth of the second gear gear the second gear teeth. The second gear drives the heating component to rotate. A fourth shaft of the fourth motor is fixed on one side of the second gear. The fourth motor drives the second gear to rotate. A sensing medium is attached below the fourth roller. One end of the sensing medium is rolled on a fifth roller. The other end of the sensing medium is disposed at a sixth roller and extends outwards. When the second gear rotates counterclockwise, the connecting rod and the heating component will be driven to move away from the sensing medium. When the second gear rotates clockwise, the connecting rod and the heating component will be driven to rotate clockwise and contact the sensing medium for printing sensing medium and for avoiding the possible collision between the tip of the thermal print head and the printed sensing medium when the latter passes by the heating component reverse to the feed direction after finishing printing and thus avoiding the problems of damages or peelings of the thermal print head and the printed thermal medium or print failure.

According to an embodiment of the present invention, the movable thermal printing device further comprises an alignment roller disposed on the sixth roller. The sensing medium passes between the alignment roller and the sixth roller.

According to an embodiment of the present invention, a circuit board is disposed below the heating component.

According to an embodiment of the present invention, the third motor and the fourth motor are stepping motors.

### BRIEF DESCRIPTION OF THE DRAWINGS

FIG. 1 shows a schematic diagram of the movable thermal printing device according to the first embodiment of the present invention;

FIG. 2 shows a side view of the movable thermal printing device according to the first embodiment of the present invention;

FIG. 3 shows a schematic diagram of the operation of the movable thermal printing device according to the present invention;

FIG. 4 shows a side view of the operation of the movable thermal printing device according to the present invention;

FIG. 5 shows a schematic diagram of the movable thermal printing device according to the second embodiment of the present invention;

FIG. 6 shows a side view of the movable thermal printing device according to the second embodiment of the present invention;

FIG. 7 shows a schematic diagram of the operation of the movable thermal printing device according to the present invention; and

FIG. 8 shows a schematic diagram of the pressing roller set of the movable thermal printing device according to the present invention.

### DETAILED DESCRIPTION

In order to make the structure and characteristics as well as the effectiveness of the present invention to be further understood and recognized, the detailed description of the present invention is provided as follows along with embodiments and accompanying figures.

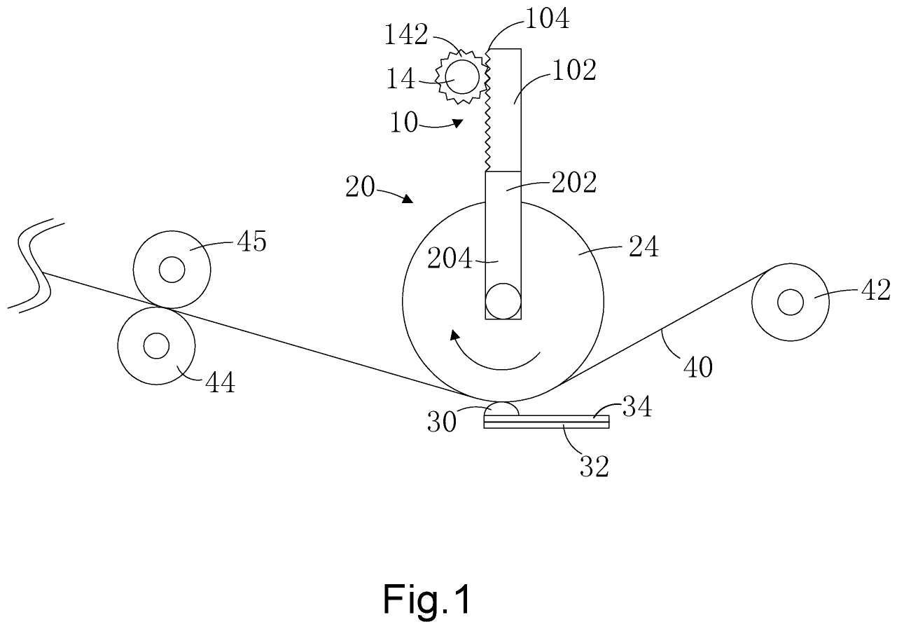

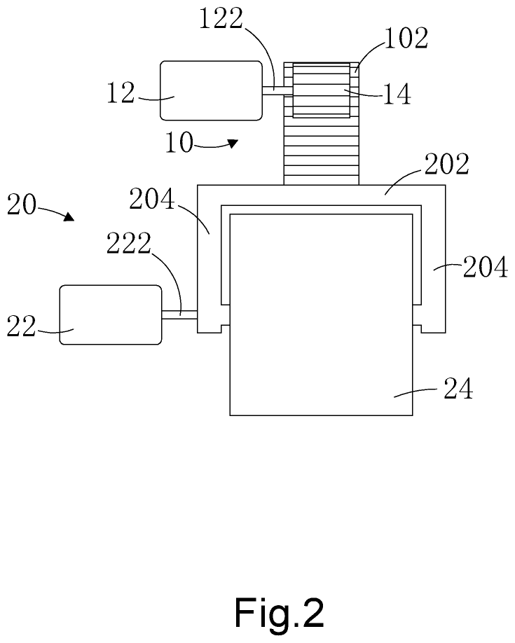

Please refer to FIG. 1 and FIG. 2, which show a schematic diagram and a side view of the movable thermal printing device according to the first embodiment of the present invention. As shown in the figures, the movable thermal printing device according to the present invention comprises a gear set 10, a pressing roller set 20, and a heating component 30. The gear set 10 further includes a first motor 12, a first gear 14, and a rack gear 102. The first motor 12 is disposed at a first shaft 122. The first gear 14 is disposed on one side of the first motor 12 and fixed at the first shaft 122. The first motor 12 drives the first gear 14 to rotate. The rack gear 102 is disposed on one side of the first gear 14. Gear teeth 104 of the rack gear 102 are in mesh with the first gear teeth 142 of the first gear 14. The first gear 14 drives the rack gear 102 to move up and down. The pressing roller set 20 further includes a frame 202, a first roller 24, and a second motor 22. The frame 202 is fixed below the rack gear 102 and extends downwards with two hanging arms 204. The first roller 24 is pivoted between the two hanging arms 204. The second motor 22 is disposed on one side of the frame 202 and a second shaft 222 of the second motor 22 is fixed at the first roller 24. The second motor 22 drives the first roller 24 to rotate. The heating component 30 is disposed below the first roller 24. A sensing medium 40 is attached below the first roller 24. One end of the sensing medium 40 is disposed at a second roller 42. The other end of the sensing medium 40 is disposed at a third roller 44 and extends outwards. When the first gear 14 rotates counterclockwise, the rack gear 102, the pressing roller set 20, and the sensing medium 40 will be driven to move upwards and away from the heating component 30. When the first gear 14 rotates clockwise, the rack gear 102, the pressing roller set 20, and the sensing medium 40 will be driven to move downwards and contact the heating component 30 for printing. By using the above structure, in the process of printing the sensing medium 40 using the movable thermal printing device, the damage problem caused by the sensing medium 40 contacting the heating component 30 occurring in the reverse movement can be avoided.

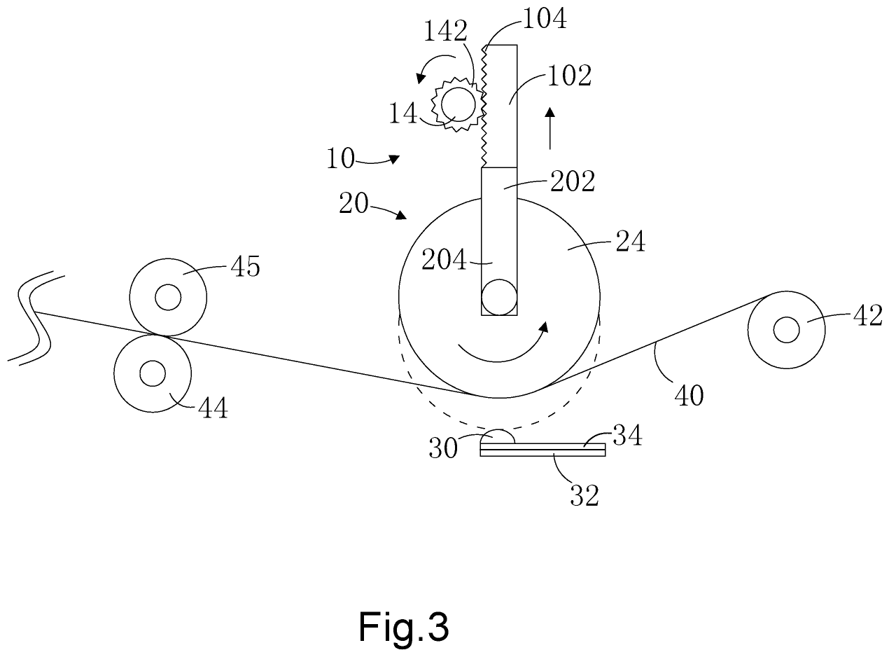

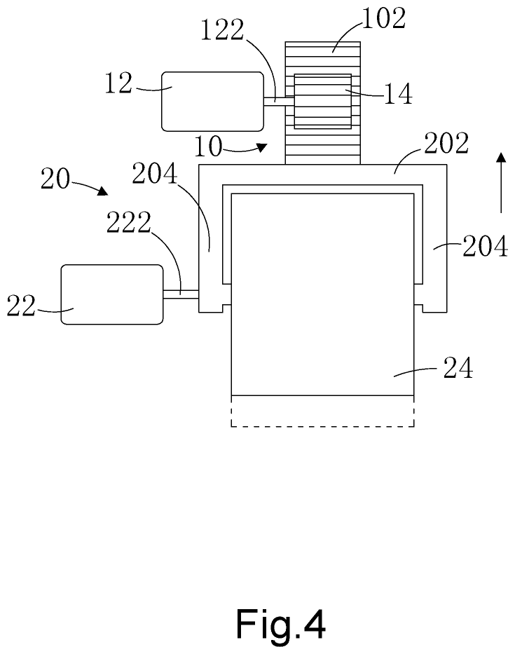

Please continue to refer to FIGS. 1 and 2, as well as to FIG. 3 and FIG. 4, which show a schematic diagram of the operation and a side view of the movable thermal printing device according to the present invention. As shown in the figures, according to the present embodiment, the movable thermal printing device comprises the gear set 10, the pressing roller set 20, and the heating component 30. A circuit board 34 is disposed below the heating component 30, and the heating component 30 is connected electrically to the circuit board 34. The pressing roller set 20 is fixed below the gear set 10. The heating component 30 is disposed below the first roller 24. The movable thermal printing device further comprises an alignment roller 45 disposed on the third roller 44. The sensing medium 40 passes between the alignment roller 45 and the third roller 44. The first motor 12 and the second motor 22 are stepping motors. In addition, the location of the sensing medium 40 passing the first roller 24 is lower than the locations where the sensing medium 40 is disposed on the second roller 42 and third roller 44. Thereby, when the first roller 24 moves upwards, a portion of the sensing medium 40 contacting the first roller 24 will attach to the first roller 24 and move upwards along with the first roller 24. Then contacts of the sensing medium 40 on the heating component 30 when the sensing medium 40 moves in the reverse direction can be avoided and thus preventing damages on the heating component 30 and the sensing medium 40.

Please continue to refer to FIGS. 1 to 4. As shown in the figures, in the printing process according to the present embodiment, first, one end of the sensing medium 40 is rolled on the second roller 42. The other end of the sensing medium 40 is disposed between the third roller 44 and the alignment roller 45 and extends outwards. The outward extending method, for example, includes that the outward extending part can be rolled on a collecting roller, which is disposed on an outer side of the third roller 44 and the alignment roller 45 for facilitating collection of the printed sensing medium 40. Besides, before printing, the first motor 12 drives the first gear 14 to rotate clockwise. Since the first gear teeth 142 are in mesh with the gear teeth 104, the first gear 14 drives the rack gear 102, the first roller 24, and a portion of the sensing medium 40 to move downward and contact the heating component 30. The circuit board 34 heats the heating component 30 and finishes printing the sensing medium 40. Next, the printed sensing medium 40 should be rolled in the reverse direction on the second roller 42. Before that, the first motor 12 drives the first gear 14 to rotate counterclockwise. The first gear 14 drives the rack gear 102, the first roller 24, and a portion of the sensing medium 40 to move upward and away from the heating component 30. The second motor 22 drives the first roller 24 to rotate counterclockwise and thus rolling the printed sensing medium 40 on the second roller 42. Moreover, to better roll the sensing medium 40 on the second roller 42, a rolling motor can be disposed on one side of the second roller 42 to supply power for rolling the sensing medium 40. By using the above structure, contacts of the printed sensing medium 40 on the heating component 30 when the sensing medium 40 is rolled in the reverse direction on the second roller 42 can be avoided. Thereby, the problems of damage and print failure can be solved.

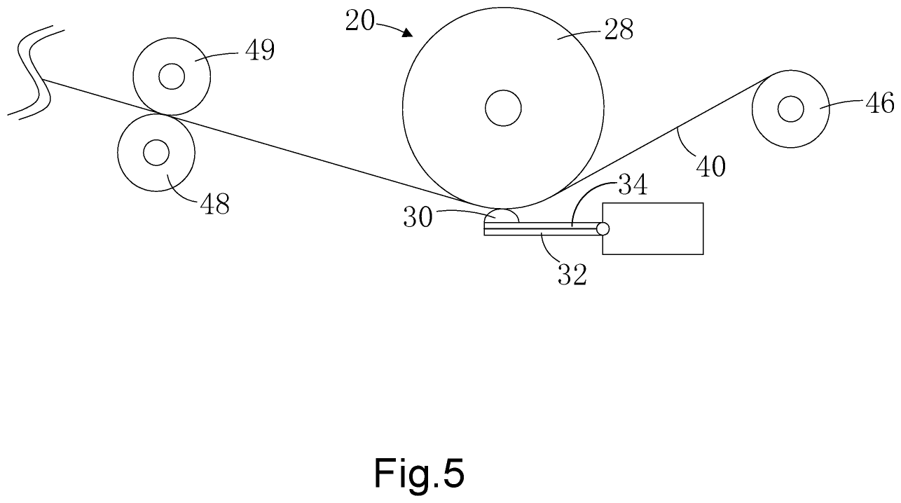

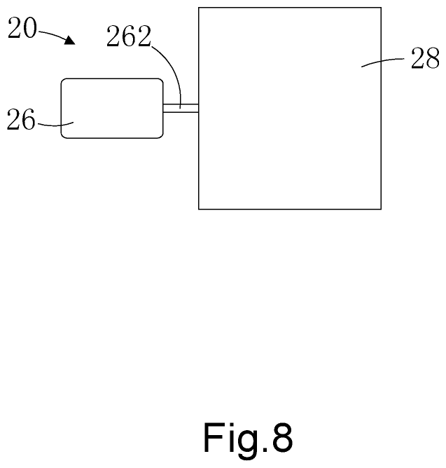

Please refer to FIGS. 5, 6, and 8, which show a schematic diagram and a side view of the movable thermal printing device and a schematic diagram of the pressing roller set according to the second embodiment of the present invention. As shown in the figures, according to the present embodiment, the movable thermal printing device according to the present invention comprises a pressing roller set 20, a heating component 30, and a gear set 10. The pressing roller set 20 further includes a fourth roller 28 and a third motor 26. A third shaft 262 of the third motor 26 is fixed on one side of the fourth roller 28, and the third motor 26 drives the fourth roller 28 to rotate. The heating component 30 is disposed below a sensing medium 40 opposite to the fourth roller 28. The heating component 30 is fixed at one end of a connecting rod 32. Second gear teeth 322 are disposed at the other end of the connecting rod 32. The gear set 10 further includes a second gear 18 and a fourth motor 16. The second gear 18 is disposed on one side of the connecting rod 32. The second gear 18 drives the heating component 30 to rotate. A fourth shaft 162 of the fourth motor 16 is fixed on one side of the second gear 18. The fourth motor 16 drives the second gear 18 to rotate. The sensing medium 40 is attached below the fourth roller 28. One end of the sensing medium 40 is rolled on a fifth roller 46. The other end of the sensing medium 40 is disposed at a sixth roller 48 and extends outwards. When the second gear 18 rotates counterclockwise, the connecting rod 32 and the heating component 30 will be driven to move away from the sensing medium 40. When the second gear 18 rotates clockwise, the connecting rod 32 and the heating component 30 will be driven to rotate clockwise and contact the sensing medium 40 for finishing printing. By using the above structure, in the process of printing the sensing medium 40 using the movable thermal printing device, the damage problem caused by the sensing medium 40 contacting the heating component 30 occurring in the reverse movement can be avoided.

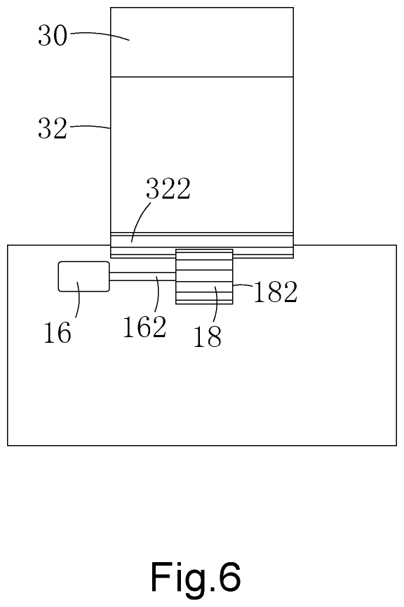

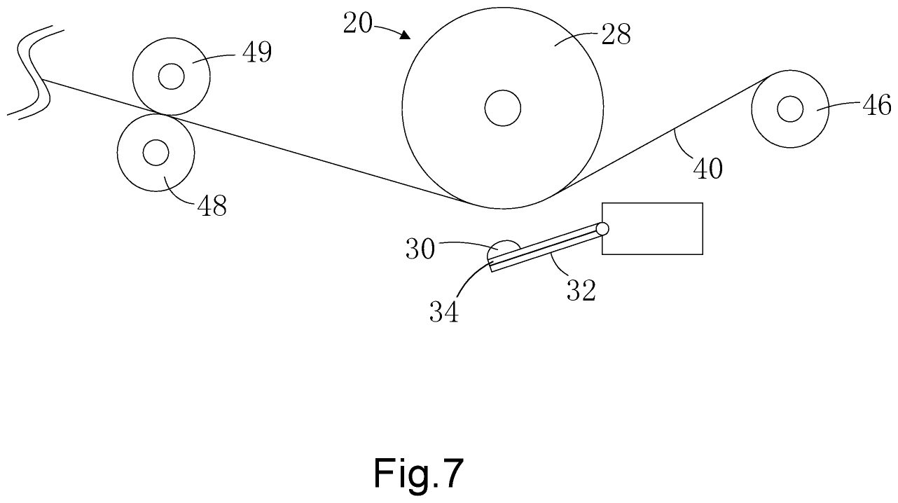

Please continue to refer to FIGS. 5 and 6, as well as to FIG. 7, which shows a schematic diagram of the operation of the movable thermal printing device according to the present invention. As shown in the figures, according to the present embodiment, the movable thermal printing device comprises the pressing roller set 20, the heating component 30, and the gear set 10. The heating component 30 is disposed below the sensing medium 40 opposite to the fourth roller 28. The heating component 30 is fixed to one end of the connecting rod 32. The second gear teeth 322 are disposed on the other end of the connecting rod 32. The gear set 10 is disposed on one side of the heating component 30. A circuit board 34 is disposed below the heating component 30 and the heating component 30 is connected electrically to the circuit board 34. The movable thermal printing device further comprises an alignment roller 49 disposed on the sixth roller 48. The sensing medium 40 passes between the alignment roller 49 and the sixth roller 48. The third motor 26 and the fourth motor 16 are stepping motors.

In addition, the location of the sensing medium 40 passing the fourth roller 28 is lower than the locations where the sensing medium 40 is disposed on the fifth roller 46 and sixth roller 48. Thereby, when the fourth roller 28 moves upwards, a portion of the sensing medium 40 contacting the fourth roller 28 will attach to the fourth roller 28 and move upwards along with the fourth roller 28. Then contacts of the sensing medium 40 on the heating component 30 when the sensing medium 40 moves in the reverse direction can be avoided.

Please continue to refer to FIGS. 5 to 8. As shown in the figures, in the printing process according to the present embodiment, first, one end of the sensing medium 40 is rolled on the fifth roller 46. The other end of the sensing medium 40 is disposed between the sixth roller 48 and the alignment roller 49 and extends outwards. The outward extending method, for example, includes that the outward extending part can be rolled on a collecting roller, which is disposed on an outer side of the sixth roller 48 and the alignment roller 49 for facilitating collection of the printed sensing medium 40. Besides, before printing, the fourth motor 16 drives the second gear 18 to rotate clockwise. Since the second gear teeth 322 gear the third gear teeth 182, the second gear 18 drives the connecting rod 32 and the heating component 30 to rotate clockwise and contact the sensing medium 40. The circuit board 34 heats the heating component 30 and finishes printing the sensing medium 40. Next, the printed sensing medium 40 should be rolled in the reverse direction on the fifth roller 46. Before that, the fourth motor 16 drives the second gear 16 to rotate counterclockwise. The second gear 16 drives the connecting rod 21 and the heating component 30 to rotate counterclockwise and away from the sensing medium 40. The third motor 26 drives the fourth roller 28 to rotate counterclockwise and thus rolling the printed sensing medium 40 on the fifth roller 46. Moreover, to better roll the sensing medium 40 on the fifth roller 46, a rolling motor can be disposed on one side of the fifth roller 46 to supply power for rolling the sensing medium 40. By using the above structure, contacts of the printed sensing medium 40 on the heating component 30 when the sensing medium 40 is rolled in the reverse direction on the second roller 42 can be avoided. Thereby, the problems of damage and print failure can be solved.

To sum up, the present invention provides a movable thermal printing device, which adopts the gear set 10, the pressing roller set 20, the heating component 30, and the sensing medium 40. The first gear 14 drives the first roller 24 to move up and down. Alternatively, the present invention adopts the pressing roller set 20, the heating component 30, the gear set 10, and the sensing medium 40. The second gear 18 drives the heating component 30 to rotate clockwise or counterclockwise. When the printed sensing medium 40 is rolled in the reverse direction on the second roller 42 or the fifth roller 46, contacts on the heating component 30 can be avoided, and thus improving the problems of damage or print failure.

1. A movable thermal printing device, comprising:
a gear set, including:
a first motor, disposed at a first shaft;
a first gear, disposed on one side of said first motor and fixed at said first shaft, and said first motor driving said first gear to rotate; and
a rack gear, disposed on one side of said first gear, gear teeth of said rack gear in mesh with first gear teeth of said first gear, and said first gear driving said rack gear to move up and down;
a pressing roller set, fixed below said gear set, and including:
a frame, fixed below said rack gear and extending downwards with two hanging arms;
a first roller, pivoted between said two hanging arms; and
a second motor, disposed on one side of said frame, a second shaft of said second motor fixed at said first roller, and said second motor driving said first roller to rotate;
a heating component, disposed below said first roller;
where a sensing medium is attached below said first roller; one end of said sensing medium is disposed at a second roller; the other end of said sensing medium is disposed at a third roller and extends outwards; when said first gear rotates counterclockwise, said rack gear, said pressing roller set, and said sensing medium will be driven to move upwards and away from said heating component; when said first gear rotates clockwise, said rack gear, said pressing roller set, and said sensing medium will be driven to move downwards and contact said heating component for printing said sensing medium.

2. The movable thermal printing device of claim 1, and further comprising an alignment roller, disposed on said third roller, and said sensing medium passing between said alignment roller and said third roller.

3. The movable thermal printing device of claim 1, wherein a circuit board is disposed below said heating component.

4. The movable thermal printing device of claim 3, wherein said first motor and said second motor are stepping motors.

5-8. (canceled)
